(19) United States
(12) Patent Application Publication
(10) Pub. No.: US 2025/0261140 A1
(43) Pub. Date: Aug. 14, 2025

(54) SYNCHRONIZATION SIGNAL BLOCK OPERATION IN NON-TERRESTRIAL NETWORK

(71) Applicant: Apple Inc., Cupertino, CA (US)

(72) Inventors: Chunxuan Ye, San Diego, CA (US); Ankit Bhamri, Haar (DE); Chunhai Yao, Beijing (CN); Dawei Zhang, Saratoga, CA (US); Fangli Xu, Beijing (CN); Haitong Sun, Saratoga (CA); Hong He, San Jose, CA (US); Jie Cui, San Jose, CA (US); Wei Zeng, Saratoga, CA (US); Yuqin Chen, Beijing (CN)

(73) Assignee: Apple Inc., Cupertino, CA (US)

(21) Appl. No.: 18/946,745

(22) Filed: Nov. 13, 2024

Related U.S. Application Data
(60) Provisional application No. 63/552,930, filed on Feb. 13, 2024.

(51) Int. Cl. H04W 56/00; H04B 7/185

(52) U.S. Cl. CPC H04W 56/001; H04B 7/18513

(57) ABSTRACT

The present application relates to devices and components including apparatus, systems, and methods to implement synchronization signal block and/or system information block less operations in non-terrestrial networks.

### CROSS-REFERENCE TO RELATED APPLICATION

This application claims priority to U.S. Provisional Patent Application No. 63/552,930, entitled “Synchronization Signal Block-less Operation in Non-terrestrial Network,” filed on Feb. 13, 2024, the disclosure of which is incorporated by reference herein in its entirety for all purposes.

### TECHNICAL FIELD

The present application relates to the field of wireless technologies and, in particular, to synchronization signal block (SSB)-less operation in non-terrestrial network (NTN).

### BACKGROUND

Third Generation Partnership Project (3GPP) networks can include non-terrestrial networks (NTNs) that can provide services to user equipments (UEs). The NTNs utilize satellites to facilitate communication with the UEs. The satellites of the NTNs can include base stations with which the UEs can establish connections or base stations located separate from the satellites can utilize the satellites to establish connections with the UEs.

The satellites can provide service to large areas. The large areas serviced by the satellites can be divided into multiple smaller areas, where the satellites can transmit transmissions via a corresponding beam to each of the smaller areas. Satellite power for the transmission of the beams can be divided between the beams being transmitted. The amount of satellite power for transmission of the beams is limited and can be a limiting factor in providing service to UEs.

### BRIEF DESCRIPTION OF THE DRAWINGS

FIG. 1 illustrates an example portion of a non-terrestrial network (NTN) arrangement in accordance with some embodiments.

FIG. 2 illustrates an example configuration information element in accordance with some embodiments.

FIG. 3 illustrates an example user equipment (UE) procedure of synchronization signal block (SSB) measurement in accordance with some embodiments.

FIG. 4 illustrates an example SSB arrangement in accordance with some embodiments.

FIG. 5 illustrates an example UE procedure of SSB measurement in accordance with some embodiments.

FIG. 6 illustrates example SSB arrangements in accordance with some embodiments.

FIG. 7 illustrates an example UE procedure of SSB measurement in accordance with some embodiments.

FIG. 8 illustrates example SSB arrangements in accordance with some embodiments.

FIG. 9 illustrates an example UE procedure for transmitting physical random access channel (PRACH) in SSB-less condition in accordance with some embodiments.

FIG. 10 illustrates an example timing arrangement in accordance with some embodiments.

FIG. 11 illustrates an example base station procedure for transmitting PRACH in SSB-less condition in accordance with some embodiments.

FIG. 12 illustrates an example procedure for SSB transmissions or system information block (SIB) transmissions of an NTN in accordance with some embodiments.

FIG. 13 illustrates an example procedure for configuring SSB transmissions or SIB transmissions of an NTN in accordance with some embodiments.

FIG. 14 illustrates an example procedure for determining a timing for a PRACH transmission in accordance with some embodiments.

FIG. 15 illustrates an example procedure for configuring a UE for PRACH transmissions in accordance with some embodiments.

FIG. 16 illustrates example beamforming circuitry in accordance with some embodiments.

FIG. 17 illustrates an example UE in accordance with some embodiments.

FIG. 18 illustrates an example next generation nodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

In non-terrestrial networks (NTNs), satellites can be utilized for communicating with user equipments (UEs). The satellites can transmit multiple beams to different coverage areas of the satellites, where transmission power of the satellites can be divided between the beams being transmitted. However, the satellites may have a limited amount of power for transmissions and dividing the power between the beams can result in reduced system performance. Approaches described herein can reduce the number of transmissions to be transmitted via the satellites, including reducing the number of transmissions to be transmitted at a time in some embodiments, which can result in increased power of transmissions by the satellites and increased performance of the system. The approaches can be applied to other entities having NTN payloads, such as high altitude platform system (HAPS), air-to-ground network elements, and/or unmanned aerial vehicles (UAVs).

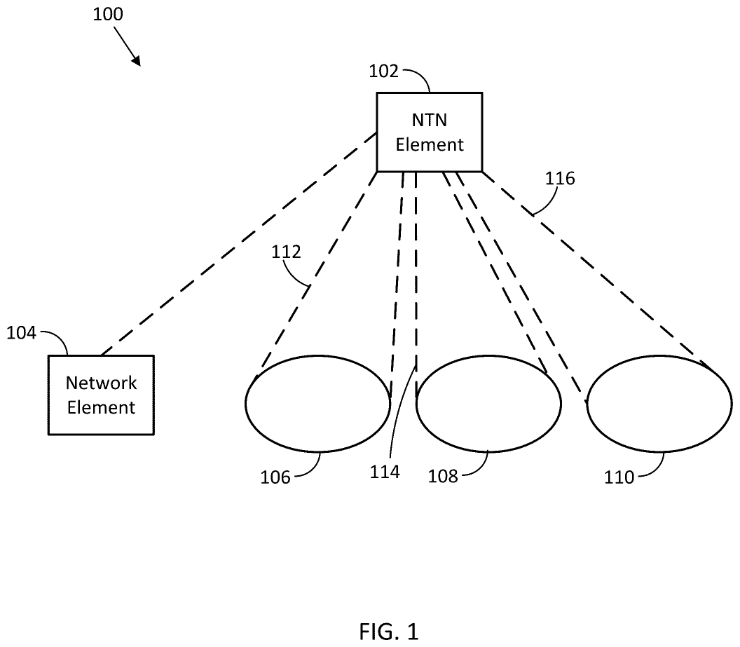

FIG. 1 illustrates an example portion of an NTN arrangement 100 in accordance with some embodiments. The NTN arrangement 100 may include devices (including hardware and/or software) for providing access to services provided by a wireless network.

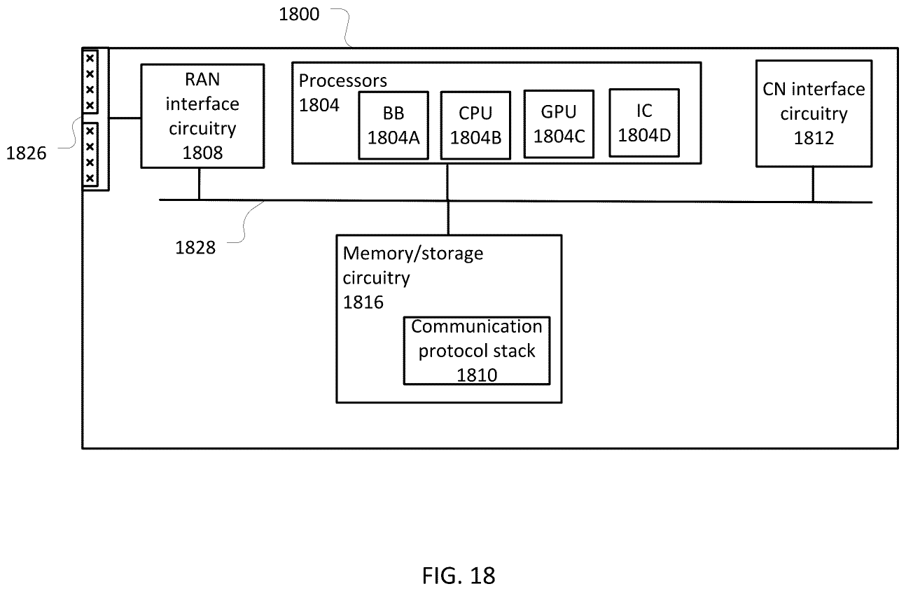

The NTN arrangement 100 may include an NTN payload 102. The NTN payload 102 may be located off the ground. For example, the NTN payload 102 may be located on or included in a satellite, an HAPS, an air-to-ground network element, and/or an unmanned vehicle. The NTN payload 102 may include one or more antennas, a power source, processing circuitry, or some combination thereof. In some embodiments, the NTN payload 102 may include a base station (such as the gNB 1800 (FIG. 18)).

The NTN payload 102 may be communicatively coupled to a network element 104. The network element 104 may be capable of providing services to user equipment (UEs) communicatively coupled to the network element 104 via the NTN payload 102. The network element 104 may include a core network, a base station, one or more antennas, or some combination thereof.

The NTN payload 102 may utilize antennas to provide connection availability to UEs located in a relatively large service area. The NTN payload 102 may divide the large service area into multiple smaller service areas, such as a first service area 106, a second service area 108, and a third service area 110 in the illustrated embodiment. The NTN payload 102 may transmit communications to the service areas using a corresponding beam. For example, the NTN payload 102 may communicate with UEs within the first service area 106 via a first beam 112, communicate with UEs within the second service area 108 via a second beam 114, and communicate with UEs within the third service area 110 via a third beam 116.

The NTN payload 102 may have a limited amount of power for transmitting communications via the beams. When communications are transmitted via multiple beams, the power available for transmission by the NTN payload 102 may be divided between the multiple beams. For example, the power may be divided between the first beam 112, the second beam 114, and the third beam 116 when the NTN payload 102 is transmitting communications to the first service area 106, the second service area 108, and the third service area 110. However, dividing the power between the beams can cause the transmission power of the communications to be relatively low, which can result in reduced service quality. As such, it can be beneficial to have fewer beams transmitting at a time such that the transmissions can have higher power as there are fewer beams for the limited amount of power to be divided between. Approaches described herein can reduce the number of beams transmitting and/or the number of transmissions being transmitted by the beams, which can result in higher transmission power for the beams transmitting and/or improved service quality as compared to legacy approaches.

Downlink coverage enhancement is desired in release 19 (Rel-19) new radio (NR NTN). This may involve physical (Phy) Channel enhancements at a link level, and satellite beamhopping optimizations at a system level.

The conclusion was that coverage enhancements for Downlink is considered as one potential objective for the Rel-19 work item (WI).

DL coverage enhancements may be considered at both link level and system level. Link level to improve the link margin of selected physical channels in order to accommodate the effective isotropic radiated power (EIRP) reduction. This may include possible techniques such as increased repetition scheme or equivalent techniques depending on the physical channel. A link margin improvement for physical channels (e.g., physical downlink shared channel (PDSCH) and physical downlink control channel (PDCCH)) may be considered without impact on synchronization signal block (SSB) design.

System level to support an efficient dynamic and flexible power sharing between beams or different beam pattern/size (i.e., wide or narrow) across the satellite foot print by leveraging techniques for network energy savings. For example, a total number of beams of 1200 may be assumed for non-geostationary orbit (NGSO) operating in frequency range 1 (FR1) band. This would correspond to the number of beams necessary to serve a satellite footprint at 30° minimum elevation with approximately 50 kilometer (km) diameter beam size.

Downlink coverage enhancement may be desired in Rel-19. The following two steps approach may be considered. In the study phase, link level and system level may be considered. At the link level, to be addressed are identify/prioritize which physical channels need to be enhanced, identify the target link margin improvement depending on the physical channel, identify/prioritize which enhancements are needed at link level/physical channels.

At the system level, to be addressed are to define reference satellite payload parameters (e.g., beam illumination plan constraints, total EIRP) and energy consumption model along with necessary evaluation methodology and relevant key performance indicators (KPIs). Further to be addressed is identify appropriate techniques in time, frequency, spatial, and power domain for NTN (Considering for example techniques addressed in release 18 (Rel-18)«Network energy savings for NR»SID/WID) and identify enhancements, if any.

In the normative phase, link level enhancements may be defined with respect to downlink physical data and control channels as appropriate (i.e. enhancements through repetition techniques). System level enhancements for NTN energy savings in time, frequency, spatial, and power domain may be defined as appropriate: i.e. enhancements enabling the use of Rel-18 Network energy savings techniques may be implemented in NTN context, considering in priority time domain techniques.

Two issues may be addressed by approaches described herein. Issue 1 is how to adjust SSB/system information block (SIB) density in NTN. The approaches described herein for addressing this may include beam based SSB density, SSB based discontinuous transmission (DTX) mode, and/or SSB transmission periodicity adjustment.

Issue 2 is how to transmit physical random access channel (PRACH) in NTN in SSB-less cases. The approaches described herein for addressing this may include UE procedure of transmitting PRACH in SSB-less condition, base state (such as next generation nodeB (gNB)) procedure of receiving PRACH in SSB-less condition, and/or signaling aspects in SSB-less.

A first approach may include SSB and/or SIB density update in NTN. The following discussion of features focuses on SSB approaches. Similar features could be applied to SIB.

A first option of the first approach (which may be referred to as Approach 1-1) may include beam-based SSB density changes. For SIB instances, Approach 1-1 may include beam-based SIB density changes. A new information element (IE) of SSBList-MTC may be introduced that is composed of SEQUENCE(SIZE(1 . . . maxSSBofCell) of SSB-MTC, where each SSB-measurement timing configuration (MTC) is for a certain SSB index. For example, a base station may generate a new IE called SSBList-MTC that can facilitate beam-based SSB density changes. The SSBList-MTC may include a sequence of SSB-MTCs for SSB indexes. The sequence of SSB-MTCs may be included in field of SEQUENCE (SIZE(1 . . . maxSSBofCell)). The SSB indexes may correspond to one or more of the beams of an NTN payload (such as the NTN payload 102). The UE may determine the SSB-MTC for beams (such as the first beam 112, the second beam 114, and/or the third beam 116) from the sequence of SSB-MTCs. The SSB-MTCs may be different for different beams. In some embodiments, the SSB-MTCs for the beams may be dependent on a geographic area corresponding to the beam, a number of UEs corresponding to the beam, and/or a number of transmissions corresponding to the beam. The NTN payload may determine an SSB index corresponding to a beam and identify an SSB-MTC for that SSB index from the sequence of SSB-MTCs. The NTN payload may then utilize the determined SSB-MTC for the beam.

In the IE of SSB-MTC, larger periodicity values are introduced, e.g., sf 320, sf 640, sf 1280, etc. For example, the SSBList-MTC may include periodicity values of 320 milliseconds (ms), 640 ms, 1280 ms, and/or other legacy periodicity values for the SSB-MTCs. The transmission of SSBList-MTC could be either carried in a SIB or carried in dedicated RRC signaling.

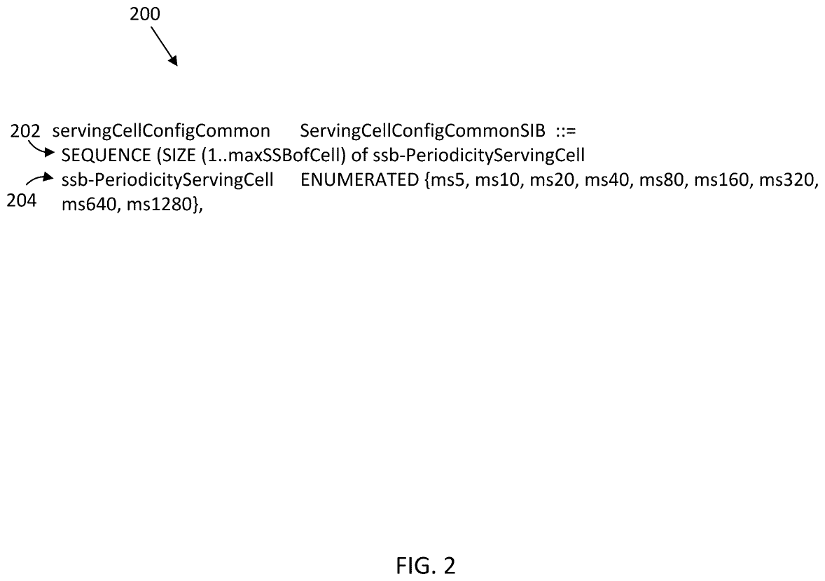

FIG. 2 illustrates an example configuration IE 200 in accordance with some embodiments. The configuration IE 200 may be a serving cell configuration common (servingCellConfigCommon) information element. A base station may transmit the configuration IE 200 to one or more UEs to implement the beam-based density update of approach 1-1.

The configuration IE 200 may include the new ssb-PeriodicityServingCell IE. In particular, the configuration IE 200 may include field 202 of SEQUENCE (SIZE(1 . . . maxSSBofCell)). The field 202 may include a sequence of ssb-PeriodicityServingCells for SSB indexes. The configuration IE 200 may further include a periodicity field 204. The periodicity field 204 may include periodicity values for the ssb-PeriodicityServingCells, including periodicity values of 5 ms, 10 ms, 20 ms, 40 ms, 80 ms, 160 ms, 320 ms, 640 ms, and 1280 ms in the illustrated embodiment.

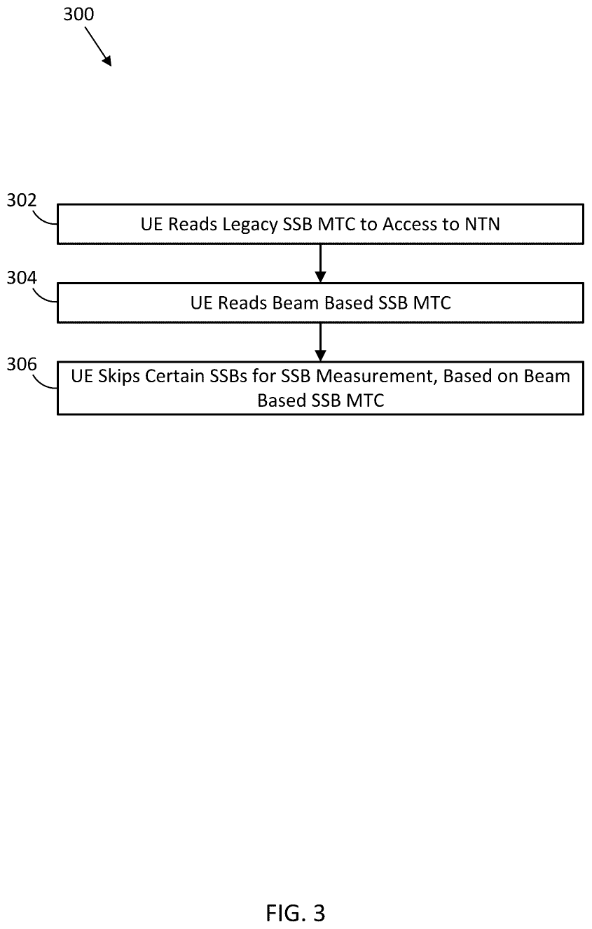

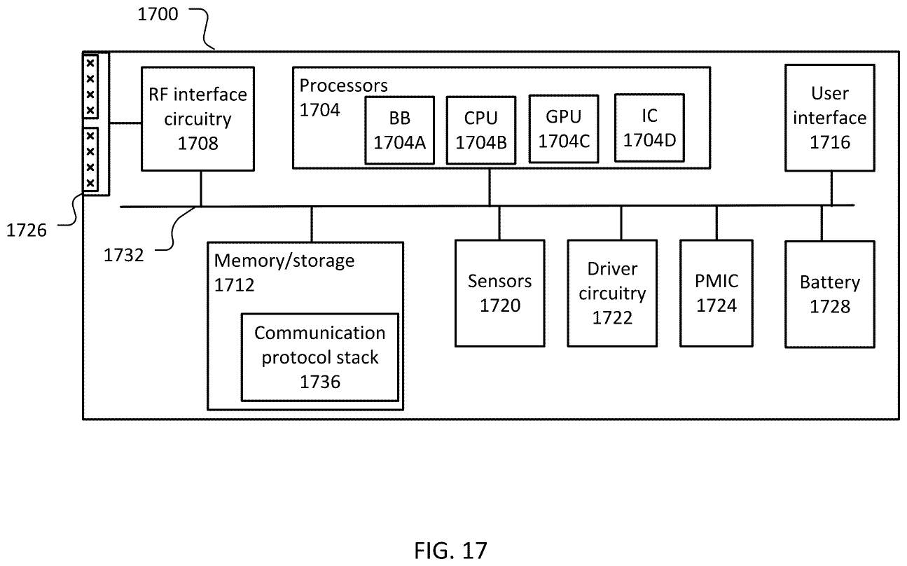

FIG. 3 illustrates an example UE procedure 300 of SSB measurement in accordance with some embodiments. In particular, the procedure 300 is an example of a procedure that may be performed by a UE (such as the UE 1700 (FIG. 17)) as part of approach 1-1.

The procedure 300 may include a UE reading legacy SSB MTC to access an NTN in 302. For example, an NTN payload (such as the NTN payload 102 (FIG. 1)) may generate a legacy SSB MTC configuration message in accordance with legacy approaches. The NTN payload may transmit the legacy SSB MTC configuration message to the UE. The UE may identify the legacy SSB MTC configuration message and read the legacy SSB MTC from the legacy SSB MTC configuration message. The UE may utilize the information read from the legacy SSB MTC to access the NTN payload. In some embodiments, the legacy SSB MTC may be carried in a transmission other than a legacy SSB MTC configuration message. Further, the procedure 300 may omit 302 in some embodiments.

The procedure 300 may include the UE reading beam based SSB MTC in 304. For example, the NTN payload may generate a beam-based SSB MTC configuration message in accordance with approach 1-1. The beam-based SSB MTC configuration message may include the new IE of SSBList-MTC. The IE of SSBList-MTC may include the sequence of SSB-MTCs in the IE of SEQUENCE(SIZE(1 . . . maxSSBofCell) of SSB-MTC. The NTN payload may transmit the beam-based SSB MTC configuration message to the UE. The UE may identify the beam-based SSB MTC configuration message received from the NTN payload. Further, the UE may read beam-based SSB-MTCs from the beam-based SSB MTC configuration message. The UE may determine the SSB-MTCs for each of the beams being transmitted by the NTN payload.

The procedure 300 may include the UE skipping certain SSBs for SSB measurement based on the beam based SSB MTC in 306. For example, the UE may determine that there are certain times that SSBs are not to be transmitted by the NTN payload based on the SSB-MTCs of the beam-based SSB MTC configuration message, whereas the legacy SSB MTC defines the SSBs as being transmitted at the certain times. The UE may determine not to monitor for SSBs and/or not to perform measurements on SSBs at the certain times.

Any one or more of the operations in FIG. 3 may be performed in a different order than shown and/or one or more of the operations may be performed concurrently in embodiments. Further, it should be understood that one or more of the operations may be omitted from and/or one or more additional operations may be added to the procedure 300 in other embodiments.

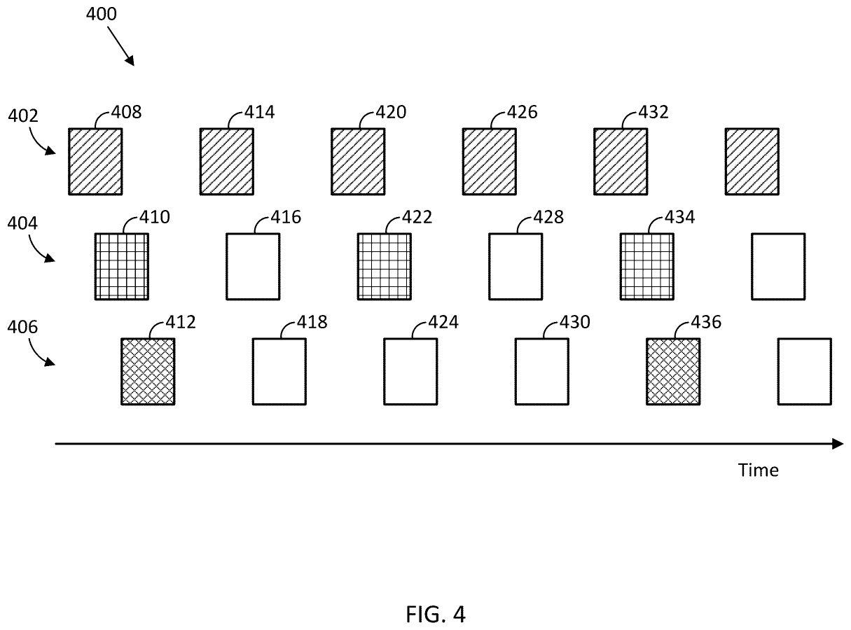

FIG. 4 illustrates an example SSB arrangement 400 in accordance with some embodiments. For example, the SSB arrangement 400 is an example of SSB transmissions that may be performed in accordance with the SSB configuration of approach 1.1.

The SSB arrangement 400 includes three rows of boxes that represent SSB transmissions or opportunities where SSB transmissions are not transmitted. Each of the rows may correspond to a beam of an NTN payload (such as the NTN payload 102 (FIG. 1)). For example, the first row 402 may correspond to a first beam of the NTN payload, the second row 404 may correspond to a second beam of the NTN payload, and the third row 406 may correspond to a third beam of the NTN payload in the illustrated embodiment. The boxes in each of the rows can indicate whether an SSB transmission has been transmitted at the opportunity or whether no SSB transmission has been transmitted at the opportunity. In particular, the boxes with fills in the SSB arrangement 400 indicate an opportunity where an SSB has been transmitted and boxes without fills in the SSB arrangement 400 indicate an opportunity where an SSB has not been transmitted. The SSB transmissions and opportunities represented in the SSB arrangement 400 are illustrated with respect to time, as illustrated by the time axis.

The illustrated embodiment represents transmissions that may be transmitted and opportunities for three beams of an NTN payload. In particular, the first row 402 corresponds to a first beam (such as the first beam 112 (FIG. 1)) of the NTN payload, the second row 404 corresponds to a second beam (such as the second beam 114 (FIG. 1)) of the NTN payload, and the third row 406 corresponds to a third beam (such as the third beam 116 (FIG. 1)) of the NTN payload. Each of the beams may be utilized for communicating with different service areas. For example, the first beam may cover a first service area (such as the first service area 106 (FIG. 1)), the second beam may cover a second service area (such as the second service area 108 (FIG. 1)), and the third beam may cover a third service area (such as the third service area 110 (FIG. 1)).

The NTN payload may be configured to transmit SSB communications at different times for the different beams. For example, the NTN payload may be configured to transmit SSBs on different beams at different periodicities. In the illustrated embodiment, the first beam represented by the first row 402 is configured with a first periodicity, the second beam represented by the second row 404 is configured with a second periodicity that is longer than the first periodicity, and the third beam represented by the third row 406 is configured with a third periodicity that is longer than both the first periodicity and the second periodicity.

The NTN payload may transmit SSB communications, and/or have SSB transmission opportunities available at approximately the same time on each of the beams (e.g., timing advance differences, or other differences, between the beams may cause time differences in corresponding SSB communications and/or SSB transmission opportunities). For example, a first SSB transmission 408 of the first beam, a second SSB transmission 410 of the second beam, and a third SSB transmission 412 of the third beam may be transmitted at approximately the same time in the illustrated embodiment.

The NTN payload may generate a beam-based SSB MTC configuration message (such as the beam-based SSB MTC configuration message described in relation to FIG. 3) that indicates the periodicities for the beams. The beam-based SSB MTC configuration message may include an SSBListMTC. The NTN payload may communicate the beam-based SSB MTC configuration message to one or more UEs to indicate the periodicities of the SSB communications being transmitted via the beams.

In the illustrated embodiment, the NTN payload may transmit the first SSB transmission 408 on the first beam, the second SSB transmission 410 on the second beam, and the third SSB transmission 412 on the third beam at approximately the same time. UEs within the corresponding service areas may monitor for the corresponding SSB transmissions and/or perform measurements of the corresponding SSB transmissions.

Due to the differences in periodicities between the beams, the NTN payload may transmit a fourth SSB transmission 414 on the first beam at a second time, while SSB transmissions may not be transmitted on the second beam during a first opportunity 416 and on the third beam during a second opportunity 418 at the second time. The UEs that received the beam-based SSB MTC configuration may be configured to determine which beam corresponds to their service. For example, UEs located within the first service area may determine that they are serviced by the first beam, UEs located within the second service area may determine that they are serviced by the second beam, and UEs located within the third service area may determine that they are serviced by the third beam. Based on the service area in which a UE is located and the information from the beam-based SSB MTC configuration message, the UE may determine when an SSB transmission is to be received by the UE from the NTN payload. In the illustrated embodiment, UEs within the first service area may determine that an SSB transmission is to be received from the NTN payload at the second time and may monitor for the SSB transmission at the second time. UEs within the second service area and the third service area may determine that an SSB transmission is not to be received from the NTN payload at the second time and may skip monitoring for the SSB transmission at the second time.

The NTN payload may transmit a fifth SSB transmission 420 on the first beam and a sixth SSB transmission 422 on the third beam, while SSB transmissions may not be transmitted on the third beam during a third opportunity 424 at a third time. The UEs within the first service area and the second service area may monitor for SSB transmissions based on the beam-based SSB MTC configuration message information at the third time. The UEs within the third service area may skip monitoring for SSB transmissions based on the beam-based SSB MTC configuration message information at the third time.

The NTN payload may transmit a seventh SSB transmission 426 on the first beam, while SSB transmissions may not be transmitted on the second beam during a fourth opportunity 428 and on the third beam during a fifth opportunity 430 at a fourth time. The UEs within the first service area may monitor for SSB transmissions during the fourth time. The UEs within the second service area may skip monitoring for SSB transmissions based on the beam-based SSB MTC configuration message information at the fourth time.

The NTN payload may transmit an eight SSB transmission 432 on the first beam, a ninth SSB transmission 434 on the second beam, and a tenth SSB transmission 436 on the third beam at a fifth time. The UEs within the first service area, the second service area, and the third service area may monitor for SSB transmissions during the fifth time.

The times between SSB transmissions where the NTN payload skips transmitting SSB transmissions (as shown by opportunities without SSB transmissions in the illustrated embodiment) may be referred to as SSB off durations of the beams. For example, the second beam may have a first SSB off duration between the second SSB transmission 410 and the sixth SSB transmission 422, and a second SSB off duration between the sixth SSB transmission 422 and the ninth SSB transmission 434 in the illustrated embodiment. The third beam may have an SSB off duration between the third SSB transmission 412 and the tenth SSB transmission 436 in the illustrated embodiment. The corresponding UEs may be configured not to monitor for SSB transmissions during these off durations, which can save signaling overhead and power of the UEs. Additionally, the NTN payload not transmitting SSB transmissions during these SSB off durations may save power of the NTN payload for the SSB transmissions, where the saved power may be utilized for boosting other communications. Accordingly, network service may be improved by implementing approach 1-1.

As mentioned, approach 1-1 may also be applied to SIB transmissions. For example, approach 1-1 may be applied to both SSB transmissions and SIB transmissions, or to either of SSB transmissions or SIB transmissions in different instances. Accordingly, one or more of the features described in relation to SSB transmission for approach 1-1 may be applied to SIB transmissions.

For example, an NTN payload may generate a beam-based SIB MTC configuration message that indicates different periodicities of SIB transmissions for different beams. The SIB MTC configuration message may include a new IE of SIBList-MTC. The IE of SIBList-MTC may include the sequence of SIB-MTCs in an IE of SEQUENCE (SIZE(1 . . . maxSIBofCell) of SIB-MTC. The NTN payload may transmit the SIB MTC configuration message to UEs. The UEs may perform one or more of the operations of the procedure 300 with the beam-based SIB MTC configuration message and SIB transmissions in place of the beam-based SSB MTC configuration message and SSB transmissions. Further, the NTN payload may implement SIB off durations for SIB transmission, similar to the SSB off durations described in relation to FIG. 4. Applying approach 1-1 to the SIBs can provide one or more of the same advantages as applying approach 1-1 to the SSBs.

A second option of the first approach (which may be referred to as Approach 1-2) may include an SSB DTX configuration. For example, a new IE of SSBDTX-config composed of SSBDTX-onDurationTimer, SSBDTX-cycle, SSBDTX-startingTime, SSBDTX-endingTime may be introduced. The transmission of SSBDTX-Config could be either carried in SIB or carried in dedicated RRC signaling. For example, an NTN payload (such as the NTN payload 102 (FIG. 1)) may determine to implement an SSB DTX configuration. The DTX configuration may include an SSB on cycle, where SSB transmissions are transmitted, and an SSB off cycle, where SSB transmissions are not transmitted. The NTN payload may generate an SSB DTX configuration message that includes the SSBDTX-config IE and may provide the SSB DTX configuration message to UEs.

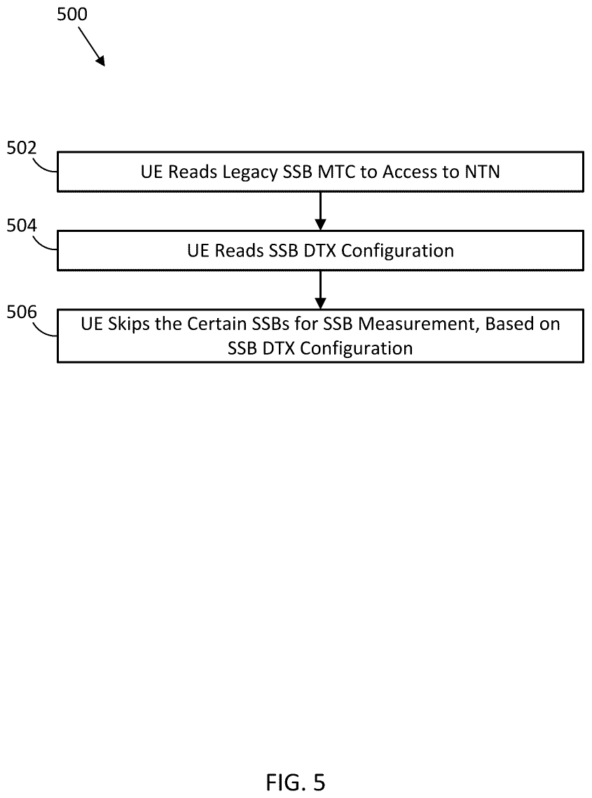

FIG. 5 illustrates an example UE procedure 500 of SSB measurement in accordance with some embodiments. In particular, the procedure 500 is an example of a procedure that may be performed by a UE (such as the UE 1700 (FIG. 17)) as part of approach 1-2.

The procedure 500 may include a UE reading legacy SSB MTC to access an NTN in 502. For example, an NTN payload (such as the NTN payload 102 (FIG. 1)) may generate a legacy SSB MTC configuration message in accordance with legacy approaches. The NTN payload may transmit the legacy SSB MTC configuration message to the UE. The UE may identify the legacy SSB MTC configuration message and read the legacy SSB MTC from the legacy SSB MTC configuration message. The UE may utilize the information read from the legacy SSB MTC to access the NTN payload. In some embodiments, the legacy SSB MTC may be carried in a transmission other than a legacy SSB MTC configuration message. Further, the procedure 500 may omit 502 in some embodiments.

The procedure 500 may include the UE reading an SSB DTX configuration in 504. For example, the NTN payload may generate an SSB DTX configuration message in accordance with approach 1-2. The SSB DTX configuration message may include the new SSB DTX configuration IE of SSBDTX-config. The SSB DTX configuration IE may include an indication of an SSB DTX on duration timer (SSBDTX-onDurationTimer), an indication of an SSB DTX cycle (SSBDTX-cycle), an indication of an SSB DTX starting time (SSBDTX-startingTime), and/or an indication of an SSB DTX ending time (SSBDTX-endingTime). The NTN payload may transmit the SSB DTX configuration message to the UE. The UE may identify the SSB DTX configuration message received from the NTN payload. Further, the UE may read SSB DTX information from the SSB DTX configuration message. The UE may determine SSB DTX information for beams being transmitted by the NTN payload.

The procedure 500 may include the UE skipping the certain SSBs for SSB measurement based on the SSB DTX configuration in 506. For example, the UE may skip monitoring and/or measuring for SSB transmissions during the SSB DTX off duration of the SSB DTX configuration.

Any one or more of the operations in FIG. 5 may be performed in a different order than shown and/or one or more of the operations may be performed concurrently in embodiments. Further, it should be understood that one or more of the operations may be omitted from and/or one or more additional operations may be added to the procedure 500 in other embodiments.

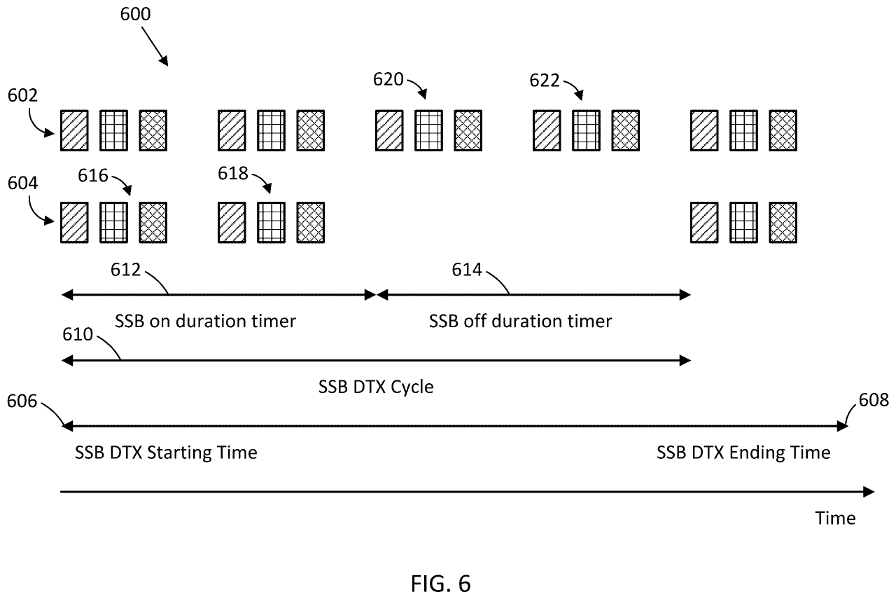

FIG. 6 illustrates example SSB arrangements 600 in accordance with some embodiments. For example, the SSB arrangements 600 illustrates example SSB transmission schedules with and without the SSB DTX configuration of approach 1-2.

The SSB arrangements 600 include a first arrangement 602 showing when SSB transmissions would be scheduled without SSB DTX configuration. For example, the first arrangement 602 illustrates an example SSB scheduling that may have been configured by a legacy SSB MTC configuration message, without the SSB DTX configuration of approach 1-2. The first arrangement 602 is shown for comparison purposes.

The SSB arrangements 600 include a second arrangement 604 showing SSB transmissions scheduled with SSB DTX configuration. For example, the second arrangement 604 illustrates an example SSB scheduling that may be configured by an SSB DTX configuration message of approach 1-2.

The second arrangement 604 may be configured with SSB DTX. For example, an NTN payload (such as the NTN payload 102 (FIG. 1)) and UEs corresponding to the second arrangement 604 may be configured with SSB DTX. The SSB DTX may be configured with an SSB DTX starting time 606 and an SSB DTX ending time 608. The SSB DTX starting time 606 may define a start time when SSB DTX operation is to be begin and the SSB DTX ending time 608 may define an end time when the SSB DTX operation is to end. The NTN payload may repeat DTX cycles of the DTX operation between the SSB DTX starting time 606 and the SSB DTX ending time 608, and may utilize normal operations outside of the times between the SSB DTX starting time 606 and the SSB DTX ending time 608.

The SSB DTX may be configured with a DTX cycle 610. Each DTX cycle 610 may include an SSB on duration time 612 and an SSB off duration time 614. DTX cycles, such as the DTX cycle 610, may continuously repeat from the SSB DTX starting time 606 to the SSB DTX ending time 608. The SSB on duration time 612 of the DTX cycle 610 may define a time duration when SSB transmissions are transmitted. The SSB off duration time 614 of the DTX cycle 610 may define a time duration when SSB transmissions are not transmitted (e.g., transmission of SSB transmissions may be avoided during the SSB off duration time 614).

The NTN payload configured with the SSB DTX configuration may generate an SSB DTX configuration message that includes an SSB DTX configuration IE of approach 1-2. The SSB DTX configuration IE may include an indication of the SSB DTX starting time 606, the SSB DTX ending time 608, the DTX cycle 610, an SSB on duration timer corresponding to the SSB on duration time 612, an SSB off duration timer corresponding to the SSB off duration time 614, or some combination thereof. The NTN payload may transmit the SSB DTX configuration message to UEs connected to the NTN payload, where the SSB DTX configuration message may configure the UEs with the SSB DTX configuration.

The NTN payload may transmit SSB transmissions at a defined periodicity during the SSB on duration time 612. The defined periodicity may be defined in the legacy SSB MTC configuration message or may be defined in the SSB DTX configuration message. In the illustrated embodiment, the NTN payload transmits a first group 616 of SSB transmissions and a second group 618 of SSB transmissions during the SSB on duration time 612. The first group 616 of SSB transmissions and the second group 618 of SSB transmissions can each include SSB transmissions on each of the beams of the NTN payload, which is three beams in the illustrated embodiment. The UEs may monitor for the SSB transmissions during the SSB on duration time 612.

The NTN payload may not transmit SSB transmissions during the SSB off duration time 614. For comparison, the first arrangement 602 showing SSB transmissions without SSB DTX configuration has a third group 620 of SSB transmissions and a fourth group 622 of SSB transmissions during the SSB off duration time 614. In contrast, the second arrangement 604 showing SSB transmissions with SSB DTX configuration do not have any SSB transmissions during the SSB off duration time 614. The UEs may be configured to skip monitoring for SSB transmissions during the SSB off duration time 614. The UEs being configured not to monitor for SSB transmissions during the SSB off duration time 614 can save signaling overhead and power of the UEs. Additionally, the NTN payload not transmitting SSB transmissions during the SSB off duration time 614 may save power of the NTN payload for the SSB transmissions, where the saved power may be utilized for boosting other communications. Accordingly, network service may be improved by implementing approach 1-2.

Approach 1-2 may also be applied to SIB transmissions. For example, approach 1-2 may be applied to both SSB transmissions and SIB transmissions, or to either of SSB transmissions or SIB transmissions in different instances. Accordingly, one or more of the features described in relation to SSB transmissions for approach 1-2 may be applied to SIB transmissions.

For example, an NTN payload may be configured for SIB DTX, where the NTN payload may not transmit SIB transmissions during an SIB off duration time (which can be similar to the SSB off duration time 614). The NTN payload may generate an SIB DTX configuration message for transmission to UEs connected to the NTN payload. The SIB DTX configuration message may configure the UEs for the SIB DTX. The SIB DTX configuration message may include a new SIB DTX configuration IE of SIBDTX-config. The SIB DTX configuration IE may include an indication of an SIB DTX on duration timer (SIBDTX-onDurationTimer), an indication of an SIB DTX cycle (SIBDTX-cycle), an indication of an SIB DTX starting time (SIBDTX-startingTime), and/or an indication of an SIB DTX ending time (SIBDTX-endingTime). The NTN payload may transmit the SIB DTX configuration message to the UEs. The UEs may identify the SIB DTX configuration message and read SIB DTX information from the SIB DTX configuration message. The UEs may determine SIB DTX information from the SIB DTX configuration message. The UEs may be configured to monitor for SIB transmissions during the SIB on duration time and skip monitoring for SIB transmissions during the SIB off duration time. Applying approach 1-2 to the SIBs can provide one or more of the same advantages as applying approach 1-2 to the SSBs.

A third option of the first approach (which may be referred to as Approach 1-3) may include enlarged SSB periodicity. For SIB instances, approach 1-3 may include enlarged SIB periodicity. A new integer factor of SSB periodic may be introduced. If the integer factor X is configured, the SSB transmission has periodicity by multiplying X. For example, the integer factor, when configured, may be multiplied by a base SSB periodicity to determine an enlarged SSB periodicity for SSB transmissions. The base SSB periodicity may be defined by legacy approaches, such as being defined by a legacy SSB MTC. The integer factor may be carried via SIB or carried in dedicated RRC signaling.

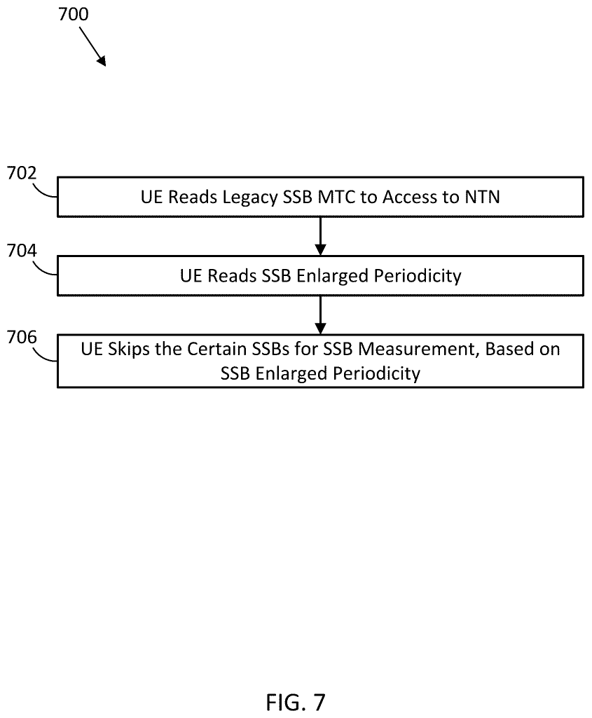

FIG. 7 illustrates an example UE procedure 700 of SSB measurement in accordance with some embodiments. In particular, the procedure 700 is an example of a procedure that may be performed by a UE (such as the UE 1700 (FIG. 17)) as part of approach 1-3.

The procedure 700 may include a UE reading legacy SSB MTC to access an NTN in 702. For example, an NTN payload (such as the NTN payload 102 (FIG. 1)) may generate a legacy SSB MTC configuration message in accordance with legacy approaches. The NTN payload may transmit the legacy SSB MTC configuration message to the UE. The UE may identify the legacy SSB MTC configuration message and read the legacy SSB MTC from the legacy SSB MTC configuration message. The UE may utilize the information read from the legacy SSB MTC to access the NTN payload. In some embodiments, the legacy SSB MTC may be carried in a transmission other than a legacy SSB MTC configuration message. Further, the procedure 700 may omit 702 in some embodiments.

The procedure 700 may include the UE reading SSB enlarged periodicity in 704. For example, the NTN payload may generate an SSB enlarged periodicity configuration message in accordance with approach 1-3. The SSB enlarged periodicity configuration message may include the new integer factor for SSB periodicity. The UE may determine the integer factor form the SSB enlarged periodicity configuration message.

The procedure 700 may include the UE skipping certain SSBs for SSB measurement based on the SSB enlarged periodicity in 706. For example, the UE may determine that there are certain times that SSBs are not to be transmitted by the NTN payload based on the SSB enlarged periodicity, whereas the legacy SSB MTC defines the SSBs as being transmitted at the certain times. The UE may determine not to monitor for SSBs and/or not to perform measurements on SSBs at the certain times.

Any one or more of the operations in FIG. 7 may be performed in a different order than shown and/or one or more of the operations may be performed concurrently in embodiments. Further, it should be understood that one or more of the operations may be omitted from and/or one or more additional operations may be added to the procedure 700 in other embodiments.

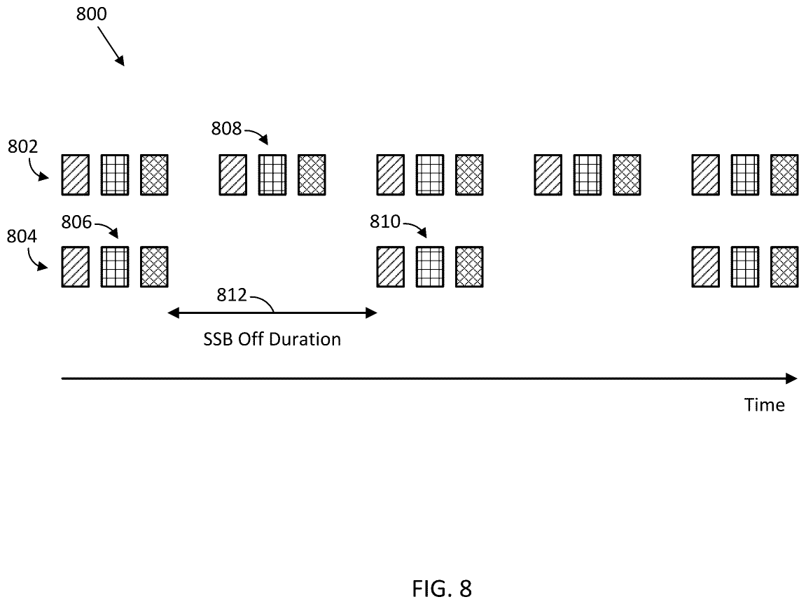

FIG. 8 illustrates example SSB arrangements 800 in accordance with some embodiments. For example, the SSB arrangements 800 illustrates example SSB transmission schedules with and without the SSB enlarged periodicity configuration of approach 1-3.

The SSB arrangements 800 include a first arrangement 802 showing when SSB transmissions would be scheduled without the SSB enlarged periodicity configuration. For example, the first arrangement 802 illustrates an example SSB scheduling that may have been configured by a legacy SSB MTC configuration message, without the SSB enlarged periodicity configuration of approach 1-3. The first arrangement 802 is shown for comparison purposes.

The SSB arrangements 800 include a second arrangement 804 showing SSB transmissions scheduled with the SSB enlarged periodicity configuration. For example, the second arrangement 804 illustrates an example SSB scheduling that may be configured by an SSB enlarged periodicity configuration message of approach 1-3.

The second arrangement 804 may be configured with an SSB enlarged periodicity. For example, an NTN payload (such as the NTN payload 102 (FIG. 1)) and UEs corresponding to the second arrangement 804 may be configured with the SSB enlarged periodicity. The SSB enlarged periodicity may be configured based on the integer factor for SSB periodicity. For example, the NTN payload may determine an integer factor for SSB transmissions to be transmitted by the NTN payload. The NTN payload may generate an SSB enlarged periodicity configuration message that includes the integer factor. The NTN payload may transmit the SSB enlarged periodicity configuration message to UEs connected to the NTN payload and the UEs may identify the SSB enlarged periodicity configuration message. The UEs may determine an SSB periodicity for SSB transmissions from the NTN payload by multiplying the integer factor from the SSB enlarged periodicity configuration message by a base periodicity. In the illustrated embodiment, the integer factor may be 2 such that the SSB enlarged periodicity is twice that of the base periodicity.

The NTN payload may transmit a first group 806 of SSB transmissions at a first time defined in accordance with the SSB enlarged periodicity. The SSB enlarged periodicity may be determined by multiplying a base periodicity (which may be defined in the legacy SSB MTC configuration message) by the integer factor. The first group 806 of SSB transmissions can include transmissions on each of the beams of the NTN payload, which is three beams in the illustrated embodiment. The UEs may monitor for the SSB transmissions at the first time based on the SSB enlarged periodicity.

The NTN payload may not transmit SSB transmissions at a second time. For comparison, the first arrangement 802 showing SSB transmissions without the SSB enlarged periodicity has a second group 808 of SSB transmissions at the second time based on an SSB periodicity that has not been modified with the SSB enlarged periodicity. In contrast, the second arrangement 804 showing SSB transmissions with the SSB enlarged periodicity do not have any SSB transmissions at the second time. The UEs may be configured to skip monitoring for SSB transmissions during the second time based on the SSB enlarged periodicity.

The NTN payload may transmit a third group 810 of SSB transmissions at a third time defined in accordance with the SSB enlarged periodicity. The UEs may monitor for the SSB transmissions at the third time based on the SSB enlarged periodicity.

The times between the SSB transmissions of the NTN payload may be referred to as an SSB off duration. For example, the second arrangement 804 has an SSB off duration 812 between the first group 806 of SSB transmissions and the third group 810 of SSB transmissions. The NTN payload may be configured not to transmit SSB transmissions during the SSB off durations and the UEs may be configured to skip monitoring for SSB transmissions during the SSB off durations. The UEs being configured not to monitor for SSB transmissions during the SSB off durations can save signaling overhead and power of the UEs.

Additionally, the NTN payload not transmitting SSB transmissions during the SSB off durations may save power of the NTN payload for the SSB transmissions, where the saved power may be utilized for boosting other communications. Accordingly, network service may be improved by implementing approach 1-3.

Approach 1-3 may also be applied to SIB transmissions. For example, approach 1-3 may be applied to both SSB transmissions and SIB transmissions, or to either of SSB transmissions or SIB transmissions in different instances. Accordingly, one or more of the features described in relation to SSB transmissions for approach 1-3 may be applied to SIB transmissions.

For example, an NTN payload may be configured with SIB enlarged periodicity, where the NTN payload may not transmit SIB transmissions during SSB off durations (which can be similar to the SSB off duration 812). The NTN payload may generate an SIB enlarged periodicity configuration message that includes an integer factor for SIB transmission configuration. The NTN payload may transmit the SIB enlarged periodicity configuration message to UEs and the UEs may identify the SIB enlarged periodicity configuration message. The UEs may determine the SIB enlarged periodicity based on the SIB enlarged periodicity configuration message. The UEs may be configured to monitor for SIB transmissions in accordance with the SIB enlarged periodicity and skip monitoring for SIB transmissions during the SSB off durations. Applying approach 1-3 to the SIBs can provide one or more of the same advantages as applying approach 1-3 to the SSBs.

In embodiments, one or more of approach 1-1, approach 1-2, approach 1-3 may be implemented independently or in combination with one or more of the other approaches. For example, the beam-based configuration of approach 1-1 may be implemented with the DTX configuration of approach 1-2 and/or the extended periodicity configuration of approach 1-3.

A second approach (which may be referred to as Approach 2) may include SSB-less operation in NTN. This applies to SSB DTX operation (approach 1-2) or enlarged SSB periodicity (approach 1-3). This applies to longer SSB off duration. For example, the SSB-less operation in NTN may apply when NTN payloads and UEs are configured with SSB off duration times (such as in approach 1-2) and/or SSB off durations (such as in approach 1-3).

UE may still transmit PRACH during SSB-less durations (which refers to the SSB off duration times and/or the SSB off durations). The PRACH may be transmitted in an uplink direction, where a timing of uplink communications can depend on downlink timing that can be indicated by SSB transmissions. When SSB transmissions are not provided during the SSB-less durations, the UE can risk not having the proper timing for transmissions in the uplink direction, including the PRACH transmissions. To address this risk, approach 2 can be implemented to make sure that the UE has the proper timing for uplink transmissions. For example, the UE may still transmit PRACH during the SSB-less duration, with the following general procedure.

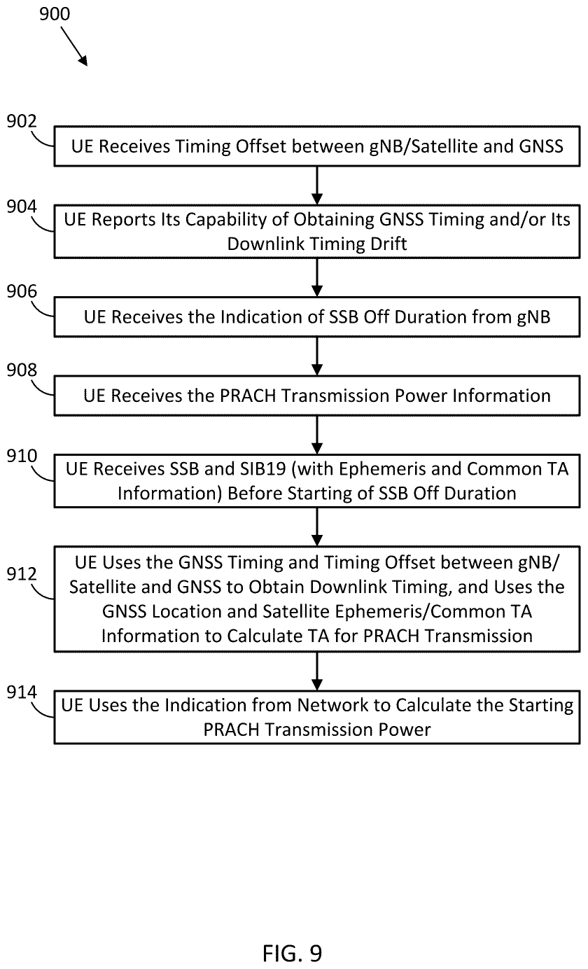

FIG. 9 illustrates an example UE procedure 900 for transmitting PRACH in SSB-less condition in accordance with some embodiments. In particular, the procedure 900 is an example of a procedure that may be performed by a UE (such as the UE 1700 (FIG. 17)) as part of approach 2.

The procedure 900 may include the UE receiving timing offset broadcast between a base station (such as the gNB 1800 (FIG. 18))/an NTN payload (such as the NTN payload 102 (FIG. 1)) and global navigation satellite system (GNSS) in 902. This timing offset may be broadcast (i.e., SIB) from the network. For example, an NTN payload may broadcast an SIB transmission to UEs that includes an indication of a timing offset between the NTN payload and a GNSS.

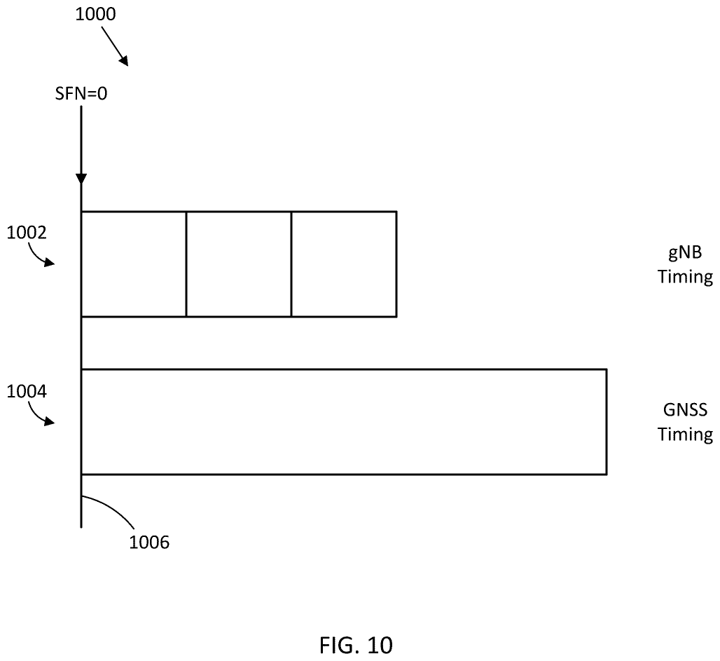

FIG. 10 illustrates an example timing arrangement 1000 in accordance with some embodiments. For example, the timing arrangement 1000 illustrates a base station/satellite timing 1002 and a GNSS timing 1004. In the illustrated embodiment, the base station/satellite timing 1002 and the GNSS timing 1004 may both start at a time 1006. Therefore, the timing offset between the base station/satellite timing 1002 and the GNSS timing 1004 may be zero. In other instances, the timing offset may be other than zero. The satellite may provide this offset timing to the UEs in 902.

The procedure 900 may include the UE reporting its capability of obtaining GNSS timing and/or its downlink timing drift to the base station (such as the gNB) in 904. For example, the UE may transmit an indication of whether it has the capability of obtaining GNSS timing and/or downlink timing drift to the NTN payload. This report may be triggered by the base station and/or the NTN payload.

The procedure 900 may include the UE receiving the indication of SSB off duration from the base station (such as gNB) in 906. For example, the NTN payload may transmit information for determining an SSB off duration time (such as in approach 1-2) and/or an SSB off duration (such as in approach 1-3) to the UE. The UE may identify the indication. This indication may be sent from the network and/or the NTN payload via SIB or dedicated radio resource control (RRC) parameter.

The procedure 900 may include the UE receiving the PRACH transmission power information in 908. In a first alternative, the power information may be broadcasted (e.g., via SIB). It may provide the relationship between UE-satellite distance and initial PRACH transmission power level. In a second alternative, the power information may be unicast (e.g., via dedicated RRC message). It may provide the direct initial PRACH transmission power level for this UE.

The procedure 900 may include, before the starting of the SSB off duration, the UE receiving SSB and/or system information block 19 (SIB19) in 910. The UE may obtain the latest ephemeris and common timing advance (TA) information with validity duration. For example, the SSB and/or the SIB 19 may include ephemeris information for the NTN payload and/or common TA information. Further, the SSB and/or the SIB 19 may indicate a validity duration for the ephemeris information and/or the common TA information.

The procedure 900 may include the UE using the GNSS timing and the timing offset between the base station/NTN payload and the GNSS to obtain downlink timing in 912. Further, the UE may use the GNSS location and satellite ephemeris/common TA information to calculate a TA for PRACH transmission.

The procedure 900 may include the UE using the indication from network to calculate the starting PRACH transmission power in 914. The procedure 900 may include the UE transmitting PRACH. For example, the UE may transmit one or more PRACH transmissions during an SSB off duration and/or an SSB off duration time. Initial PRACH transmission power may depend on UE-satellite distance, which may be calculated by UE GNSS location and satellite location, based on gNB indicated distance to power mapping rule. UE may transmit PRACH via beam sweeping or based on the satellite ephemeris information.

Any one or more of the operations in FIG. 9 may be performed in a different order than shown and/or one or more of the operations may be performed concurrently in embodiments. Further, it should be understood that one or more of the operations may be omitted from and/or one or more additional operations may be added to the procedure 900 in other embodiments.

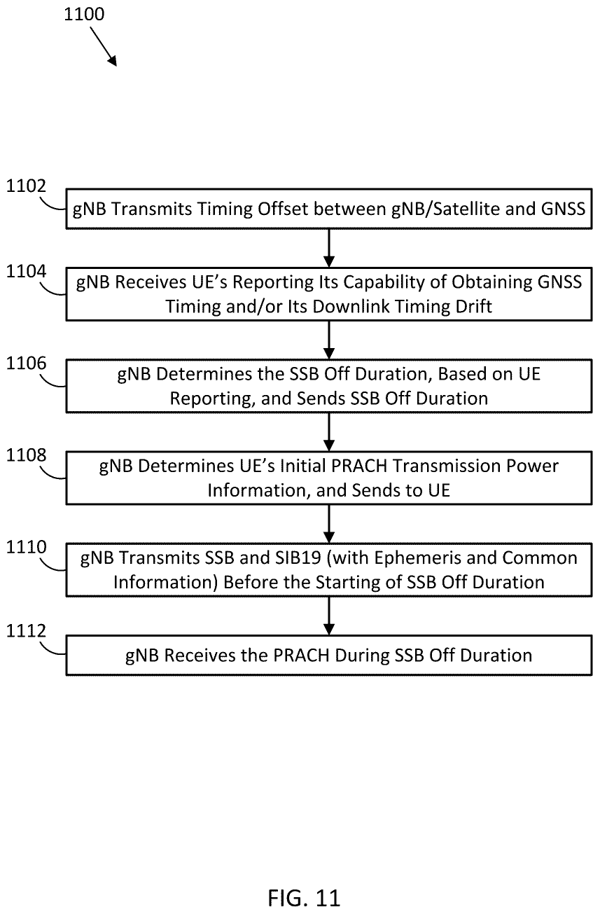

FIG. 11 illustrates an example base station procedure 1100 for transmitting PRACH in SSB-less condition in accordance with some embodiments. In particular, the procedure 1100 is an example procedure that may be performed by a base station (such as the gNB 1800 (FIG. 18)) and/or an NTN payload (such as the NTN payload 102 (FIG. 1)) as part of approach 2. The procedure 1100 may correspond to the procedure 900, where the procedure 1100 is performed by the base station and/or NTN payload while the corresponding procedure 900 is performed by the UE.

The procedure 1100 may include the base station (such as the gNB) and/or the NTN payload transmitting timing offset between the base station/NTN payload and a GNSS in 1102. In particular, the base station and/or the NTN payload may transmit an indication of the timing offset to the UE.

The procedure 1100 may include the base station and/or the NTN payload receiving the UE's report of its capability of obtaining GNSS timing and/or downlink timing drift in 1104. If the UE capability indicates that the UE supports obtaining GNSS timing and/or downlink timing drift, the procedure 1100 may proceed. If the UE capability indicates that the UE does not support obtaining GNSS timing and/or downlink timing drift, the procedure 1100 may be terminated.

The procedure 1100 may include the base station and/or the NTN payload determining the SSB off duration (such as the SSB off duration time in approach 1-2 and/or the SSB off duration in approach 1-3), based on UE reporting, and sending SSB off duration to the UE in 1106.

The procedure 1100 may include the base station and/or the NTN payload determining the UE's initial PRACH transmission power information and sending the initial PRACH transmission power information to the UE in 1108.

The procedure 1100 may include the base station and/or the NTN payload transmitting SSB and SIB 19 (with ephemeris and common information) before starting the SSB off duration in 1110.

The procedure 1100 may include the base station and/or the NTN payload receiving the PRACH during the SSB off duration in 1112.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

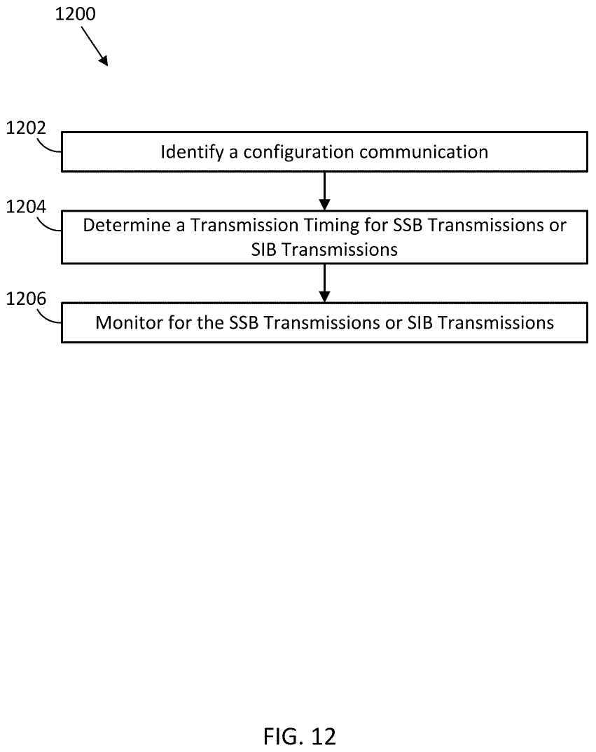

FIG. 12 illustrates an example procedure 1200 for SSB transmissions or SIB transmissions of an NTN in accordance with some embodiments. The procedure 1200 may be performed by a UE, such as the UE 1700 (FIG. 17).

The procedure 1200 may include identifying a configuration communication in 1202. For example, the UE may identify a configuration communication that provides information for SSB transmissions or SIB transmissions of an NTN network. In some embodiments, the SSB transmissions or the SIB transmissions are to be transmitted via a satellite of the NTN. The configuration communication may be received via an SIB or dedicated RRC signaling in some embodiments.

In some embodiments, the configuration communication may include a beam-based configuration that indicates periodicities for multiples beams of the NTN. For example, the beam-based configuration may be as described in relation to approach 1-1. The beam-based configuration may include an SSBList-MTC IE or an SIBList-MTC IE that defines the periodicities for the multiple beams in some embodiments. In some embodiments, the periodicities for the multiple beams may include a first periodicity for a first beam and a second periodicity for a second beam.

In some embodiments, the configuration communication may include a DTX configuration for the SSB transmissions or the SIB transmissions. For example, the DTX configuration may be as described in relation to approach 1-2. The DTX configuration may include a DTX on duration timer IE, a DTX cycle IE, a DTS starting time IE, and/or a DTX ending time IE for the SSB transmissions or the SIB transmissions.

In some embodiments, the configuration communication may include a multiplication factor for the SSB transmissions or the SIB transmissions. For example, the configuration communication may include an integer factor (such as the integer factor of approach 1-3) as the multiplication factor.

The procedure 1200 may include determining a transmission timing for the SSB transmissions or SIB transmissions in 1204.

In some embodiments, determining the transmission timing may include determining a periodicity for a beam corresponding to a processor performing the method from the periodicities for the multiple beams. For example, the periodicity may be determined in accordance with approach 1-1. The periodicity may include a 320 ms, a 640 ms, or a 1280 ms periodicity in some embodiments.

In some embodiments, determining the transmission timing may include determining an on duration for the DTX configuration. For example, the on duration may be determined in accordance with approach 1-2 and/or approach 1-3. Determining the transmission timing may include determining an off duration for the DTX configuration in some embodiments. For example, the off duration may be determined in accordance with approach 1-2 and/or approach 1-3.

The procedure 1200 may include monitoring for SSB transmissions or SIB transmissions in 1206. For example, the UE may monitor for the SSB transmissions or the SIB transmissions in accordance with the transmission timing. In some embodiments, monitoring for the SSB transmissions or the SIB transmissions may include monitoring for the SSB transmissions or the SIB transmissions during the on duration. In some embodiments, the procedure 1200 may include refraining from monitoring for other SSB transmissions or other SIB transmissions during the off duration.

Any one or more of the operations in FIG. 12 may be performed in a different order than shown and/or one or more of the operations may be performed concurrently in embodiments. Further, it should be understood that one or more of the operations may be omitted from and/or one or more additional operations may be added to the procedure 1200 in other embodiments.

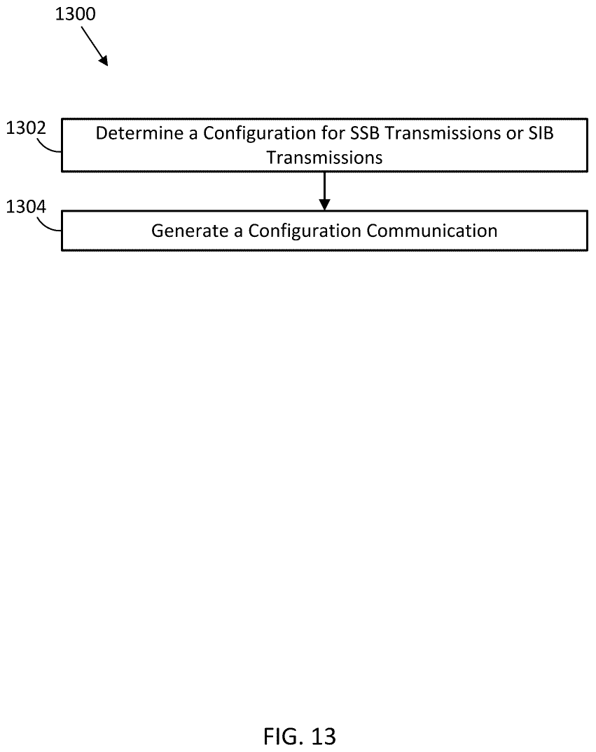

FIG. 13 illustrates an example procedure 1300 for configuring SSB transmissions or SIB transmissions of an NTN in accordance with some embodiments. The procedure 1300 may be performed by a base station (such as the gNB 1800 (FIG. 18)) and/or an NTN payload, such as the NTN payload 102 (FIG. 1). For brevity, the procedure is described as being performed by an NTN payload.

The procedure 1300 may include determining a configuration for SSB transmissions or SIB transmissions in 1302. For example, the NTN payload may determine a configuration for SSB transmissions or SIB transmissions for an NTN. In some embodiments, the SSB transmissions or the SIB transmissions may be transmitted via a satellite of the NTN.

In some embodiments, the configuration may include a beam-based configuration that include periodicities for multiple beams of the NTN. For example, beam-based configuration may be as described in relation to approach 1-1. The periodicities for the multiple beams may include a first periodicity for a first beam and a second periodicity for a second beam in some embodiments.

In some embodiments, the configuration may include a DTX configuration for the SSB transmissions or the SIB transmissions. For example, the DTX configuration may be as described in relation to approach 1-2. The DTX configuration may include a DTX on duration timer IE, a DTX cycle IE, a DTX starting time IE, and/or a DTX ending time IE for the SSB transmissions or the SIB transmissions in some embodiments.

In some embodiments, the configuration may include a multiplication factor for a periodicity of the SSB transmissions or the SIB transmissions. For example, the configuration communication may include an integer factor (such as the integer factor of approach 1-3) as the multiplication factor.

The procedure 1300 may include generating a configuration communication in 1304. For example, the NTN payload may generate a configuration communication that provides configuration information for the configuration for transmission to a UE connected to the NTN. In some embodiments, the UE may be connected to the NTN via the satellite. In some embodiments, the configuration communication may be transmitted via an SIB or dedicated RRC signaling.

In some embodiments, the configuration information may indicate the periodicities for multiple beams. The configuration information may include an SSBList-MTC IE that indicates the periodicities for multiple beams in some embodiments. In some embodiments, at least one periodicity of the periodicities for the multiple beams may include a periodicity of 320 ms, 640 ms, or 1280 ms.

In some embodiments, the configuration information may include the DTX configuration. The procedure 1300 may further including transmitting the SSB transmissions or the SIB transmissions during an on duration time of a DTX cycle of the DTX configuration in some embodiments. Further, the procedure 1300 may include refraining from transmission of the SSB transmissions or the SIB transmissions during an off duration time of the DTX cycle.

In some embodiments, the configuration information may include the multiplication factor.

In some embodiments, the procedure 1300 may further include generating SSB transmissions or SIB transmissions for transmission in accordance with the configuration.

Any one or more of the operations in FIG. 13 may be performed in a different order than shown and/or one or more of the operations may be performed concurrently in embodiments. Further, it should be understood that one or more of the operations may be omitted from and/or one or more additional operations may be added to the procedure 1300 in other embodiments.

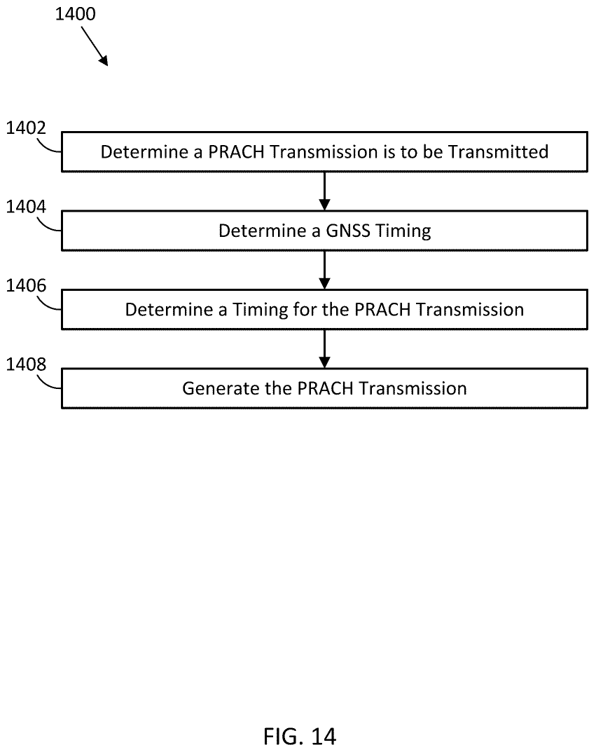

FIG. 14 illustrates an example procedure 1400 for determining a timing for a PRACH transmission in accordance with some embodiments. The procedure 1400 may be performed by a UE, such as the UE 1700 (FIG. 17). The procedure 1400 may be performed as part of approach 2 and may implement one or more of the features of approach 2.

The procedure 1400 may include determining a PRACH transmission is to be transmitted in 1402. For example, the UE may determine a PRACH transmission is to be transmitted via an NTN during a period when corresponding SSBs are not scheduled. In some embodiments, the procedure 1400 may further include generating a capability report for transmission that indicates whether GNSS timing obtainment or downlink timing drift is supported.

The procedure 1400 may include determining a GNSS timing in 1404. For example, the UE may determine a GNSS timing for a GNSS.

The procedure 1400 may include determining a timing for the PRACH transmission in 1406. For example, the UE may determine a timing for the PRACH transmission based at least in part on the GNSS timing.

The procedure 1400 may include generating the PRACH transmission in 1408. For example, the UE may generate the PRACH transmission to be transmitted at the determined timing. In some embodiments, the PRACH transmission is to be transmitted via a satellite of the NTN.

In some embodiments, the procedure 1400 may further include identifying a timing offset between the satellite and the GNSS. In some of these embodiments, determining the timing for the PRACH may include applying the timing offset to the GNSS timing.

In some embodiments, the procedure 1400 may further include identifying ephemeris information for the satellite. The procedure 1400 may further include identifying common TA information in some embodiments. In some embodiments, determining the timing for the PRACH may include determining a TA for the PRACH based at least in part on the ephemeris information or the common TA information.

In some embodiments, the procedure 1400 may further include identifying an indication of an SSB off duration. Determining the PRACH transmission is to be transmitted during the period when corresponding SSBs are not scheduled may include determining that the PRACH is to be transmitted during the SSB off duration in some embodiments.

In some embodiments, the procedure 1400 may further include identifying PRACH power information. The procedure 1400 may further include determining a PRACH transmission power for the PRACH transmission based at least in part on the PRACH transmission power information in some embodiments.

Any one or more of the operations in FIG. 14 may be performed in a different order than shown and/or one or more of the operations may be performed concurrently in embodiments. Further, it should be understood that one or more of the operations may be omitted from and/or one or more additional operations may be added to the procedure 1400 in other embodiments.

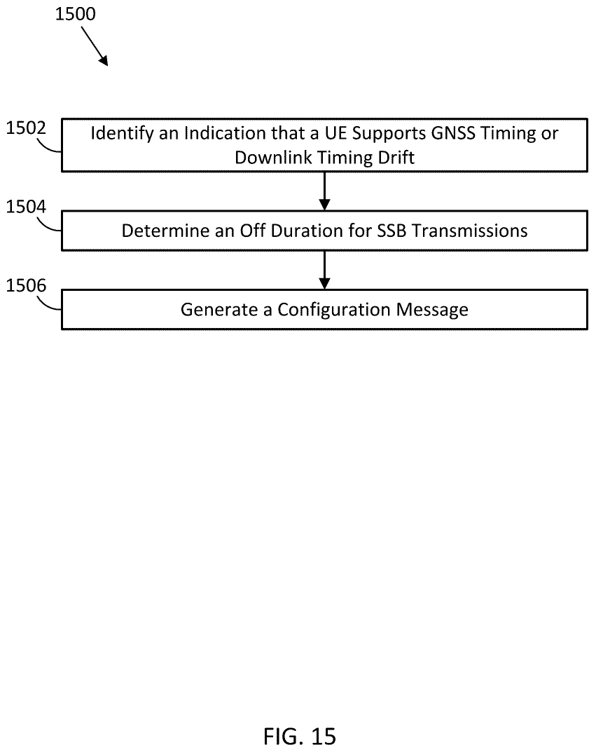

FIG. 15 illustrates an example procedure 1500 for configuring a UE for PRACH transmissions in accordance with some embodiments. The procedure 1500 may be performed by a base station (such as the gNB 1800 (FIG. 18)) and/or an NTN payload (such as the NTN payload 102 (FIG. 1)). For brevity, the procedure 1500 is described as being performed by the NTN payload. The procedure 1500 may be performed as part of approach 2 and may implement one or more of the features of approach 2.

The procedure 1500 may include identifying an indication that a UE supports GNSS timing or downlink timing drift in 1502.

In some embodiments, the procedure 1500 may further include generating a timing offset message that indicates a timing offset to the GNSS timing for transmission to the UE.

The procedure 1500 may include determining an off duration for SSB transmissions in 1504.

The procedure 1500 may include generating a configuration message in 1506. For example, the NTN payload may generate a configuration message that indicates the off duration for transmission to the UE.

In some embodiments, the procedure 1500 may further include determining initial PRACH transmission power information for a PRACH transmission of the UE. The procedure 1500 may further include generating a PRACH transmission power communication that includes the PRACH transmission power information for transmission to the UE in some embodiments.

In some embodiments, the procedure 1500 may further include generating an SIB 19 message for transmission to the UE, the SIB19 message including ephemeris information for a satellite corresponding to the UE and common TA information. The procedure 1500 may further include identifying a PRACH transmission received from the UE during the off duration.

Any one or more of the operations in FIG. 15 may be performed in a different order than shown and/or one or more of the operations may be performed concurrently in embodiments. Further, it should be understood that one or more of the operations may be omitted from and/or one or more additional operations may be added to the procedure 1500 in other embodiments.

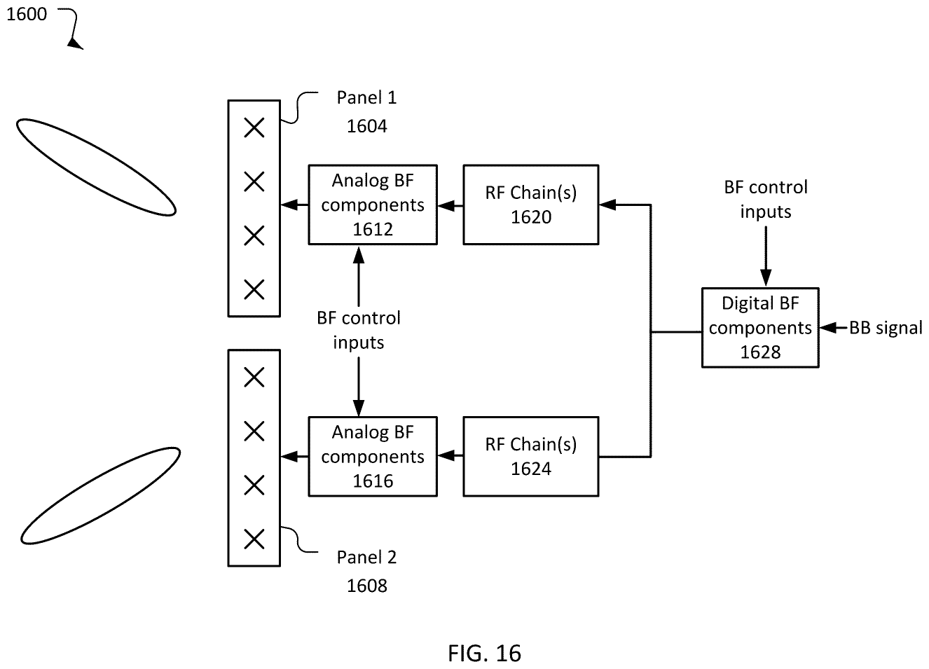

FIG. 16 illustrates example beamforming circuitry 1600 in accordance with some embodiments. The beamforming circuitry 1600 may include a first antenna panel, panel 1 1604, and a second antenna panel, panel 2 1608. Each antenna panel may include a number of antenna elements. Other embodiments may include other numbers of antenna panels.

Digital beamforming (BF) components 1628 may receive an input baseband (BB) signal from, for example, a baseband processor such as, for example, baseband processor 1704A of FIG. 17. The digital BF components 1628 may rely on complex weights to pre-code the BB signal and provide a beamformed BB signal to parallel radio frequency (RF) chains 1620/1624.

Each RF chain 1620/1624 may include a digital-to-analog converter to convert the BB signal into the analog domain; a mixer to mix the baseband signal to an RF signal; and a power amplifier to amplify the RF signal for transmission.

The RF signal may be provided to analog BF components 1612/1616, which may apply additionally beamforming by providing phase shifts in the analog domain. The RF signals may then be provided to antenna panels 1604/1608 for transmission.

In some embodiments, instead of the hybrid beamforming shown here, the beamforming may be done solely in the digital domain or solely in the analog domain.

In various embodiments, control circuitry, which may reside in a baseband processor, may provide BF weights to the analog/digital BF components to provide a transmit beam at respective antenna panels. These BF weights may be determined by the control circuitry to provide the directional provisioning of the serving cells as described herein. In some embodiments, the BF components and antenna panels may operate together to provide a dynamic phased-array that is capable of directing the beams in the desired direction.

FIG. 17 illustrates an example UE 1700 in accordance with some embodiments. The UE 1700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1700 may be a RedCap UE or NR-Light UE.

The UE 1700 may include processors 1704, RF interface circuitry 1708, memory/storage 1712, user interface 1716, sensors 1720, driver circuitry 1722, power management integrated circuit (PMIC) 1724, antenna structure 1726, and battery 1728. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangement of the components shown may occur in other implementations.

The components of the UE 1700 may be coupled with various other components over one or more interconnects 1732, which may represent any type of interface, input/output, bus (local, system, or expansion), transmission line, trace, optical connection, etc. that allows various circuit components (on common or different chips or chipsets) to interact with one another.

The processors 1704 may include processor circuitry such as, for example, baseband processor circuitry (BB) 1704A, central processor unit circuitry (CPU) 1704B, and graphics processor unit circuitry (GPU) 1704C. The processors 1704 may include any type of circuitry or processor circuitry that executes or otherwise operates computer-executable instructions, such as program code, software modules, or functional processes from memory/storage 1712 to cause the UE 1700 to perform operations as described herein.

In some embodiments, the baseband processor circuitry 1704A may access a communication protocol stack 1736 in the memory/storage 1712 to communicate over a 3GPP compatible network. In general, the baseband processor circuitry 1704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1708.

The baseband processor circuitry 1704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1712 may include one or more non-transitory, computer-readable media that includes instructions (for example, communication protocol stack 1736) that may be executed by one or more of the processors 1704 to cause the UE 1700 to perform various operations described herein. The memory/storage 1712 include any type of volatile or non-volatile memory that may be distributed throughout the UE 1700. In some embodiments, some of the memory/storage 1712 may be located on the processors 1704 themselves (for example, L1 and L2 cache), while other memory/storage 1712 is external to the processors 1704 but accessible thereto via a memory interface. The memory/storage 1712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1708 may include transceiver circuitry and radio frequency front module (RFEM) that allows the UE 1700 to communicate with other devices over a radio access network. The RF interface circuitry 1708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1726 and proceed to filter and amplify (with a low-noise amplifier) the signal. The signal may be provided to a receiver of the transceiver that down-converts the RF signal into a baseband signal that is provided to the baseband processor of the processors 1704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1726.

In various embodiments, the RF interface circuitry 1708 may be configured to transmit/receive signals in a manner compatible with NR access technologies.

The antenna structure 1726 may include antenna elements to convert electrical signals into radio waves to travel through the air and to convert received radio waves into electrical signals. The antenna elements may be arranged into one or more antenna panels.

The antenna structure 1726 may have antenna panels that are omnidirectional, directional, or a combination thereof to enable beamforming and multiple input, multiple output communications. The antenna structure 1726 may include microstrip antennas, printed antennas fabricated on the surface of one or more printed circuit boards, patch antennas, phased array antennas, etc. The antenna structure 1726 may have one or more panels designed for specific frequency bands including bands in FR1 or FR2.

In some embodiments, the UE 1700 may include the beamforming circuitry 1600 (FIG. 16), where the beamforming circuitry 1600 may be utilized for communication with the UE 1700. In some embodiments, components of the UE 1700 and the beamforming circuitry may be shared. For example, the antennas 1726 of the UE may include the panel 1 1604 and the panel 2 1608 of the beamforming circuitry 1600.

The user interface 1716 includes various input/output (I/O) devices designed to enable user interaction with the UE 1700. The user interface 1716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1700.

The sensors 1720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1722 may include software and hardware elements that operate to control particular devices that are embedded in the UE 1700, attached to the UE 1700, or otherwise communicatively coupled with the UE 1700. The driver circuitry 1722 may include individual drivers allowing other components to interact with or control various input/output (I/O) devices that may be present within, or connected to, the UE 1700. For example, driver circuitry 1722 may include a display driver to control and allow access to a display device, a touchscreen driver to control and allow access to a touchscreen interface, sensor drivers to obtain sensor readings of sensor circuitry 1720 and control and allow access to sensor circuitry 1720, drivers to obtain actuator positions of electro-mechanic components or control and allow access to the electro-mechanic components, a camera driver to control and allow access to an embedded image capture device, audio drivers to control and allow access to one or more audio devices.

The PMIC 1724 may manage power provided to various components of the UE 1700. In particular, with respect to the processors 1704, the PMIC 1724 may control power-source selection, voltage scaling, battery charging, or DC-to-DC conversion.

In some embodiments, the PMIC 1724 may control, or otherwise be part of, various power saving mechanisms of the UE 1700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1700 may power down for brief intervals of time and thus save power. If there is no data traffic activity for an extended period of time, then the UE 1700 may transition off to an RRC_Idle state, where it disconnects from the network and does not perform operations such as channel quality feedback, handover, etc. The UE 1700 goes into a very low power state and it performs paging where again it periodically wakes up to listen to the network and then powers down again. The UE 1700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1728 may power the UE 1700, although in some examples the UE 1700 may be mounted deployed in a fixed location, and may have a power supply coupled to an electrical grid. The battery 1728 may be a lithium ion battery, a metal-air battery, such as a zinc-air battery, an aluminum-air battery, a lithium-air battery, and the like. In some implementations, such as in vehicle-based applications, the battery 1728 may be a typical lead-acid automotive battery.

FIG. 18 illustrates an example gNB 1800 in accordance with some embodiments. The gNB 1800 may include processors 1804, RF interface circuitry 1808, core network (CN) interface circuitry 1812, memory/storage circuitry 1816, and antenna structure 1826.

The components of the gNB 1800 may be coupled with various other components over one or more interconnects 1828.

The processors 1804, RF interface circuitry 1808, memory/storage circuitry 1816 (including communication protocol stack 1810), antenna structure 1826, and interconnects 1828 may be similar to like-named elements shown and described with respect to FIG. 17.

The CN interface circuitry 1812 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1800 via a fiber optic or wireless backhaul. The CN interface circuitry 1812 may include one or more dedicated processors or FPGAs to communicate using one or more of the aforementioned protocols. In some implementations, the CN interface circuitry 1812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying a configuration communication that provides information for synchronization signal block (SSB) transmissions or system information block (SIB) transmissions of a non-terrestrial network (NTN), determining a transmission timing for the SSB transmissions or the SIB transmissions based at least in part on the configuration communication, and monitoring for the SSB transmissions or the SIB transmissions in accordance with the transmission timing.

Example 2 may include the method of example 1, wherein the SSB transmissions or the SIB transmissions are to be transmitted via a satellite of the NTN.

Example 3 may include the method of example 1, wherein the configuration communication includes a beam-based configuration that indicates periodicities for multiple beams of the NTN, and determining the transmission timing includes determining a periodicity for a beam corresponding to a processor performing the method from the periodicities for the multiple beams.

Example 4 may include the method of example 3, wherein the beam-based configuration includes an SSBList-MTC information element or an SIBList-MTC information element that defines the periodicities for the multiple beams.

Example 5 may include the method of example 3, wherein the periodicity includes a 320 millisecond (ms), a 640 ms, or a 1280 ms periodicity.

Example 6 may include the method of example 3, wherein the periodicities for the multiple beams includes a first periodicity for a first beam and a second periodicity for a second beam.

Example 7 may include the method of example 1, wherein the configuration communication includes a discontinuous transmission (DTX) configuration for the SSB transmissions or the SIB transmissions, determining the transmission timing includes determining an on duration for the DTX configuration, and monitoring for the SSB transmissions or the SIB transmissions includes monitoring for the SSB transmissions or the SIB transmissions during the on duration.

Example 8 may include the method of example 7, wherein determining the transmission timing includes determining an off duration for the DTX configuration, and wherein the method further comprises refraining from monitoring for other SSB transmissions or other SIB transmissions during the off duration.

Example 9 may include the method of example 7, wherein the DTX configuration includes a DTX on duration timer information element, a DTX cycle information element, a DTX starting time information element, or a DTX ending time information element for the SSB transmissions or the SIB transmissions.

Example 10 may include the method of example 1, wherein the configuration communication includes a multiplication factor for the SSB transmissions or the SIB transmissions, and determining the transmission timing includes determining a base periodicity for the SSB transmissions or the SIB transmissions, and determining a periodicity for the SSB transmissions or the SIB transmissions based at least in part on multiplying the base periodicity by the multiplication factor.

Example 11 may include the method of example 1, wherein the configuration communication is received via an SIB or dedicated radio resource control (RRC) signaling.

Example 12 may include a method comprising determining a configuration for synchronization signal block (SSB) transmissions or system information block (SIB) transmissions of a non-terrestrial network (NTN), and generating a configuration communication that provides configuration information for the configuration for transmission to a user equipment (UE) connected to the NTN.

Example 13 may include the method of example 12, wherein the SSB transmissions or the SIB transmissions are to be transmitted via a satellite of the NTN, and wherein the UE is connected to the NTN via the satellite.

Example 14 may include the method of example 12, further comprising generating SSB transmissions or SIB transmissions for transmission in accordance with the configuration.

Example 15 may include the method of example 12, wherein the configuration includes a beam-based configuration that includes periodicities for multiple beams of the NTN, and the configuration information indicates the periodicities for the multiple beams.

Example 16 may include the method of example 15, wherein the configuration information includes an SSBList-MTC information element that indicates the periodicities for the multiple beams.

Example 17 may include the method of example 15, wherein the periodicities for the multiple beams include a first periodicity for a first beam and a second periodicity for a second beam.

Example 18 may include the method of example 15, wherein at least one periodicity of the periodicities for the multiple beams includes a periodicity of 320 milliseconds (ms), 640 ms, or 1280 ms.

Example 19 may include the method of example 12, wherein the configuration includes a discontinuation transmission (DTX) configuration for the SSB transmissions or the SIB transmissions, and the configuration information includes the DTX configuration.

Example 20 may include the method of example 19, the DTX configuration include a DTX on duration timer information element, a DTX cycle information element, a DTX starting time information element, or a DTX ending time information element for the SSB transmissions or the SIB transmissions.

Example 21 may include the method of example 19, further comprising transmitting the SSB transmissions or the SIB transmissions during an on duration time of a DTX cycle of the DTX configuration, and refraining from transmission of the SSB transmissions or the SIB transmissions during an off duration time of the DTX cycle.

Example 22 may include the method of example 12, wherein the configuration includes a multiplication factor for a periodicity of the SSB transmissions or the SIB transmissions, and the configuration communication includes the multiplication factor.

Example 23 may include the method of example 12, wherein the configuration communication is to be transmitted via an SIB or dedicated radio resource control (RRC) signaling.

Example 24 may include a method comprising determining a physical random access channel (PRACH) transmission is to be transmitted via a non-terrestrial network (NTN) during a period when corresponding synchronization signal blocks (SSBs) are not scheduled, determining a global navigation satellite system (GNSS) timing for a GNSS, determining a timing for the PRACH transmission based at least in part on the GNSS timing, and generating the PRACH transmission to be transmitted at the determined timing.

Example 25 may include the method of example 24, wherein the PRACH transmission is to be transmitted via a satellite of the NTN.

Example 26 may include the method of example 25, further comprising identifying a timing offset between the satellite and the GNSS, wherein determining the timing for the PRACH includes applying the timing offset to the GNSS timing.

Example 27 may include the method of example 26, further comprising identifying ephemeris information for the satellite, and identifying common timing advance (TA) information, wherein determining the timing for the PRACH includes determining a (TA) for the PRACH based at least in part on the ephemeris information or the common TA information.

Example 28 may include the method of example 24, further comprising generating a capability report for transmission that indicates whether GNSS timing obtainment or downlink timing drift is supported.

Example 29 may include the method of example 24, further comprising identifying an indication of an SSB off duration, wherein determining the PRACH transmission is to be transmitted during the period when corresponding SSBs are not scheduled includes determining that the PRACH is to be transmitted during the SSB off duration.

Example 30 may include the method of example 24, further comprising identifying PRACH transmission power information, and determining a PRACH transmission power for the PRACH transmission based at least in part on the PRACH transmission power information.

Example 31 may include a method comprising identifying an indication that a user equipment (UE) supports obtaining global navigation satellite (GNSS) timing or downlink timing drift, determining an off duration for synchronization signal block (SSB) transmissions, and generating a configuration message that indicates the off duration for transmission to the UE.

Example 32 may include the method of example 31, further comprising generating a timing offset message that indicates a timing offset to the GNSS timing for transmission to the UE.

Example 33 may include the method of example 31, further comprising determining initial physical random access channel (PRACH) transmission power information for a PRACH transmission of the UE, and generating a PRACH transmission power communication that includes the PRACH transmission power information for transmission to the UE.

Example 34 may include the method of example 31, further comprising generating a system information block 19 (SIB19) message for transmission to the UE, the SIB19 message including ephemeris information for a satellite corresponding to the UE and common timing advance (TA) information.

Example 35 may include the method of example 31, further comprising identifying a physical random access channel (PRACH) transmission received from the UE during the off duration.

Example 36 may include an apparatus comprising means to perform one or more elements of a method described in or related to any of examples 1-35, or any other method or process described herein.

Example 37 may include one or more non-transitory computer-readable media comprising instructions to cause an electronic device, upon execution of the instructions by one or more processors of the electronic device, to perform one or more elements of a method described in or related to any of examples 1-35, or any other method or process described herein.

Example 38 may include an apparatus comprising logic, modules, or circuitry to perform one or more elements of a method described in or related to any of examples 1-35, or any other method or process described herein.

Example 39 may include a method, technique, or process as described in or related to any of examples 1-35, or portions or parts thereof.

Example 40 may include an apparatus comprising: one or more processors and one or more computer-readable media comprising instructions that, when executed by the one or more processors, cause the one or more processors to perform the method, techniques, or process as described in or related to any of examples 1-35, or portions thereof.

Example 41 may include a signal as described in or related to any of examples 1-35, or portions or parts thereof.

Example 42 may include a datagram, information element, packet, frame, segment, PDU, or message as described in or related to any of examples 1-35, or portions or parts thereof, or otherwise described in the present disclosure.

Example 43 may include a signal encoded with data as described in or related to any of examples 1-35, or portions or parts thereof, or otherwise described in the present disclosure.

Example 44 may include a signal encoded with a datagram, IE, packet, frame, segment, PDU, or message as described in or related to any of examples 1-35, or portions or parts thereof, or otherwise described in the present disclosure.

Example 45 may include an electromagnetic signal carrying computer-readable instructions, wherein execution of the computer-readable instructions by one or more processors is to cause the one or more processors to perform the method, techniques, or process as described in or related to any of examples 1-35, or portions thereof.

Example 46 may include a computer program comprising instructions, wherein execution of the program by a processing element is to cause the processing element to carry out the method, techniques, or process as described in or related to any of examples 1-35, or portions thereof.

Example 47 may include a signal in a wireless network as shown and described herein.

Example 48 may include a method of communicating in a wireless network as shown and described herein.

Example 49 may include a system for providing wireless communication as shown and described herein.

Example 50 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a configuration communication that provides information for synchronization signal block (SSB) transmissions or system information block (SIB) transmissions of a non-terrestrial network (NTN);
determine a transmission timing for the SSB transmissions or the SIB transmissions based at least in part on the configuration communication; and
monitor for the SSB transmissions or the SIB transmissions in accordance with the transmission timing.

2. The one or more non-transitory, computer-readable media of claim 1, wherein the SSB transmissions or the SIB transmissions are to be transmitted via a satellite of the NTN.

3. The one or more non-transitory, computer-readable media of claim 1, wherein:
the configuration communication includes a beam-based configuration that indicates periodicities for multiple beams of the NTN; and
to determine the transmission timing includes to determine a periodicity for a beam corresponding to processing circuitry from the periodicities for the multiple beams.

4. The one or more non-transitory, computer-readable media of claim 3, wherein the beam-based configuration includes an SSBList-MTC information element or an SIBList-MTC information element that defines the periodicities for the multiple beams.

5. The one or more non-transitory, computer-readable media of claim 3, wherein the periodicity includes a 320 millisecond (ms), a 640 ms, or a 1280 ms periodicity.

6. The one or more non-transitory, computer-readable media of claim 1, wherein:
the configuration communication includes a discontinuous transmission (DTX) configuration for the SSB transmissions or the SIB transmissions;
to determine the transmission timing includes to determine an on duration for the DTX configuration; and
to monitor for the SSB transmissions or the SIB transmissions includes to monitor for the SSB transmissions or the SIB transmissions during the on duration.

7. The one or more non-transitory, computer-readable media of claim 6, wherein to determine the transmission timing includes to determine an off duration for the DTX configuration, and wherein the instructions, when executed further cause the processing circuitry to:
refrain from monitoring for other SSB transmissions or other SIB transmissions during the off duration.

8. The one or more non-transitory, computer-readable media of claim 1, wherein:
the configuration communication includes a multiplication factor for the SSB transmissions or the SIB transmissions; and
to determine the transmission timing includes to:
determine a base periodicity for the SSB transmissions or the SIB transmissions; and
determine a periodicity for the SSB transmissions or the SIB transmissions based at least in part on multiplying the base periodicity by the multiplication factor.

9. A method comprising:
determining a configuration for synchronization signal block (SSB) transmissions or system information block (SIB) transmissions of a non-terrestrial network (NTN); and
generating a configuration communication that provides configuration information for the configuration for transmission to a user equipment (UE) connected to the NTN.

10. The method of claim 9, wherein the SSB transmissions or the SIB transmissions are to be transmitted via a satellite of the NTN, and wherein the UE is connected to the NTN via the satellite.

11. The method of claim 9, further comprising:
generating SSB transmissions or SIB transmissions for transmission in accordance with the configuration.

12. The method of claim 9, wherein:
the configuration includes a beam-based configuration that includes periodicities for multiple beams of the NTN; and
the configuration information indicates the periodicities for the multiple beams.

13. The method of claim 9, wherein:
the configuration includes a discontinuation transmission (DTX) configuration for the SSB transmissions or the SIB transmissions; and
the configuration information includes the DTX configuration.

14. The method of claim 13, further comprising:
transmitting the SSB transmissions or the SIB transmissions during an on duration time of a DTX cycle of the DTX configuration; and
refraining from transmission of the SSB transmissions or the SIB transmissions during an off duration time of the DTX cycle.

15. The method of claim 9, wherein:
the configuration includes a multiplication factor for a periodicity of the SSB transmissions or the SIB transmissions; and
the configuration communication includes the multiplication factor.

16. An apparatus comprising:
processing circuitry to:
determine a physical random access channel (PRACH) transmission is to be transmitted via a non-terrestrial network (NTN) during a period when corresponding synchronization signal blocks (SSBs) are not scheduled;
determine a global navigation satellite system (GNSS) timing for a GNSS;
determine a timing for the PRACH transmission based at least in part on the GNSS timing; and
generate the PRACH transmission to be transmitted at the determined timing; and
interface circuitry coupled with the processing circuitry, the interface circuitry to enable communication.

17. The apparatus of claim 16, wherein the PRACH transmission is to be transmitted via a satellite of the NTN.

18. The apparatus of claim 17, wherein the processing circuitry is further to:
identify a timing offset between the satellite and the GNSS, wherein to determine the timing for the PRACH includes to apply the timing offset to the GNSS timing.

19. The apparatus of claim 16, wherein the processing circuitry is further to:
generate a capability report for transmission that indicates whether GNSS timing obtainment or downlink timing drift is supported.

20. The apparatus of claim 16, wherein the processing circuitry is further to:
identify an indication of an SSB off duration, wherein to determine the PRACH transmission is to be transmitted during the period when corresponding SSBs are not scheduled includes to determine that the PRACH is to be transmitted during the SSB off duration.
